(19) United States
(12) Patent Application Publication
(10) Pub. No.: US 2011/0301282 A1
(43) Pub. Date: Dec. 8, 2011

(54) BLACK COLORED MASTER BATCH CARBON NANOTUBE AND METHOD OF MANUFACTURE THEREOF

(76) Inventor: Eric Magni, Quebec (CA)

(21) Appl. No.: 13/151,932

(22) Filed: Jun. 2, 2011

Related U.S. Application Data
(60) Provisional application No. 61/351,167, filed on Jun. 3, 2010.

(51) Int. Cl. C08L 23/12; C08L 23/06; B82Y 30/00

(52) U.S. Cl. 524/528; 524/583; 524/587; 524/585; 977/742

(57) ABSTRACT

A black plastic formed from between about 0.01% and 0.3% carbon nanotube material by weight.

### CROSS-REFERENCE TO RELATED APPLICATIONS

This application claims the benefit of priority to U.S. Provisional Application No. 61/351,167, filed Jun. 3, 2010 in its entirety.

### BACKGROUND OF THE INVENTION

This invention is directed to the formation of black colored plastic parts, and in particular, the use of a color master batch which acts as less of a contaminant within the plastic matrix without degrading color.

It is well known in the art to utilize carbon black within the plastic matrix to provide black coloring to injection molded objects. It is known in the art to create a master batch containing carbon black mixed with at least one of a linear low density polyethylene (LLDPE), a low density polyethylene (LDPE), a high density polyethylene (HDPE) or a polypropylene (PP). The carbon black is mixed with the other components so that the final master batch is 40-50% carbon black by weight. The master batch is then again mixed into a polymer matrix to create black colored polymer matrix. The master batch is mixed so that the master batch makes up 1-3% by weight of the final polymer matrix and the carbon black is present at levels between 0.4-1.5% by weight of the overall polymer matrix.

The prior art coloring techniques have been satisfactory. However, any time a nonpolymer material is added to a polymer matrix, it is a contaminant. Therefore, the additions of color filler in the polymer affect the mechanical and physical properties of the polymer matrix, mostly with negative effects.

Accordingly, a black master batch which overcomes the shortcomings of the prior art is desired.

### SUMMARY OF THE INVENTION

Carbon nanotube material is combined with at least one of LLDPE, LDPE, HDPE or PP to create a coloring master batch. The color master batch includes up to 15% of the carbon nanotube material by weight. The color master batch is then combined utilizing a twin screw extruder with other polymers to make a shot material for the injection molding process. The color master batch is loaded into the final polymer matrix so that the final polymer matrix includes 0.01% to 0.3% nanotube material by weight.

### DETAILED DESCRIPTION OF THE PREFERRED EMBODIMENT

A black colored resin is made by combining a carbon nanotube material, such as that made by Nanocyl, as the coloring agent with polymers such as at least one of linear low density polyethylene (LLDPE), low density polyethylene (LDPE), high density polyethylene (HDPE) or polypropylene (PP) to create a color master batch having up to about 40%, and preferably, about 15% by weight of carbon nanotube material therein. In a preferred embodiment the mixture is made by use of twin screw extruders.

The color master batch is then mixed with a polymer matrix containing one or more of LLDPE, LDPE, HDPE and PP utilizing a plastics transformation process. Extrusion and/or injection are the preferred, but nonlimiting, processes to create a polymer matrix. The color master batch is mixed into the polymer matrix so that the polymer matrix contains between about 0.01% and 0.3%, and preferably about 0.015% nanotube material by weight.

By utilizing black nanotube material, the same degree of color is provided utilizing as little as 1/100 of the contaminant (coloring additive) by weight. As a result of the reduced use of coloring additive, the initial mechanical and physical properties of the polymer are conserved and some, such as toughness and rigidity for example, may be significantly improved.

The final matrix is a plastic resin utilized as the shot for the injection molding of a plastic product.

The instant invention has been shown and described herein in what is considered to be the most practical and preferred embodiment. However, it is recognized that departures may be made therefrom within the scope of the invention and the obvious modifications will occur to a person skilled in the art.

1. A black plastic produced formed from between about 0.01% and 0.3% carbon nanotube material by weight.

2. A black plastic product of claim 1, formed of one or more of low density polyethylene, linear low density polyethylene, high density polyethylene and polypropylene.

3. A black colored master batch comprising a polymer and up to about 40% by weight of carbon nanotube material.

4. A black colored master batch of claim 3, formed of one or more of low density polyethylene, linear low density polyethylene, high density polyethylene and polypropylene.

5. A method for creating a black plastic product comprising the steps of:
providing carbon nanotube material;
providing a polymer;
mixing the carbon nanotube material with the polymer to create a master batch containing up to about 40% carbon nanotube material by weight;
loading the master batch material into a second polymer to create a plastic shot containing therein between about 0.01% and 0.3% carbon nanotube material by weight.

6. The method of claim 5, wherein the polymer is one of linear low density polyethylene, low density polyethylene, high density polyethylene and polypropylene.

7. The method of claim 5, wherein the second polymer is one of linear low density polyethylene, low density polyethylene, high density polyethylene and polypropylene.

8. The method of claim 5, wherein the plastic shot contains about 0.015% nanotube material by weight.

9. The method of claim 5, wherein the master batch contains about 15% carbon nanotube material by weight.
